(19) United States
(12) Patent Application Publication
(10) Pub. No.: US 2005/0190898 A1
(43) Pub. Date: Sep. 1, 2005

(54) Message exchange server allowing near real-time exchange of messages, and method

(76) Inventors: Craig Priest, Etobicoke (CA); Grant Hood, Etobicoke (CA)

Correspondence Address: FOGG AND ASSOCIATES, LLC, P.O. BOX 581339, MINNEAPOLIS, MN, 55458-1339, US

(21) Appl. No.: 10/788,249

(22) Filed: Feb. 26, 2004

(51) Int. Cl. H04M 11/00; H04M 1/64

(52) U.S. Cl. 379/88.18; 379/88.22

(57) ABSTRACT

A method provides users of a system facilitating the exchange of messages in near-real time, the option of hearing greetings of other users currently in communication with the system and sending messages to them, and of hearing greetings of users who were previously in communication with the system to exchange messages in near real-time. Thus, current users can hear greetings of others who they missed. Advantageously, current users may spend more time using the system listening to messages of users no longer connected to the system.

### FIELD OF THE INVENTION

The present invention relates to personal introduction and message exchange services, such as dating services, and more particularly to methods and devices for allowing near real-time exchange of messages.

### BACKGROUND OF THE INVENTION

Over the past several years, personal message exchange services, such as computer and telephone based dating and introduction services have become increasingly popular. These services offer users a convenient and time-efficient way to contact, and eventually meet others for romantic or social purposes.

Typically, users of such services can access a main server operated by a service provider, usually by using a telephone or a computer terminal. By way of such access, each user can browse a pool of personal greetings and personal information left by others; create his or her own personal greeting and personal information profile; check his or her personal mailbox for messages sent by others; and send personal messages to the mailboxes of others.

Alternatively, or additionally, users may join conferences between two or more other users. The conferences may be by way of the exchange of messages in near real-time. Such conferences are often colloquially referred to as “chat rooms”. Advantageously, chatrooms enable users to communicate with others on an anonymous basis. Furthermore, chat rooms make the initial contact between users less socially awkward and intimidating than if the users were to employ more conventional means, such as making direct telephone calls or even leaving messages.

Often access to a particular service is provided by telephone. A user accessing a server hosting the service is usually directed through a series of voice menus to the pool of stored personal greetings. Typically, the user will listen to the personal greetings and may originate a message to the mailbox of recipients that the caller might be interested in meeting. At some later time, a recipient may access an associated personal mailbox, check received messages, and decide whether to respond to those messages. Where the recipient responds to a message by sending another message to the message originator, the two may start an exchange that may ultimately lead to a face-to-face meeting, and possibly to a relationship.

Many personal introduction and message exchange services typically generate revenues by charging users for actual use of the service. For telephone based services, use based charges may easily be levied by tracking the time spent recording messages for others or listening to messages in a mailbox. Service providers thus strive to make use of the provided service interesting, so that users spend more time using provided services.

Interest in the near-real time exchange of messages (i.e. chat) services is highly dependent on the number of users currently using the provided service. The fewer people connected to the service at a given time, the less interest others have in remaining connected for near real-time message exchange.

It would, therefore, be desirable to allow users engaged in near real time message exchange an additional variety of messages to listen and respond to.

### SUMMARY OF THE INVENTION

In accordance with the present invention, users of a system facilitating the exchange of messages in near-real time, are given the option of hearing greetings of other users currently in communication with the system and sending messages to them, and of hearing greetings of users who were previously in communication with the system to exchange messages in real-time. Thus, current users can hear who they missed. Advantageously, current users may spend more time using the system listening to messages of users no longer connected to the system.

The invention may be embodied in a suitably adapted message exchange system or software stored on a computer readable medium.

In accordance with an aspect of the present invention, there is provided a method of operating a system providing a service allowing a plurality of users to communicate with each other in near real-time. The method includes: for each of the users storing a temporary greeting; allowing users currently in communication with the system to receive temporary greetings of other users currently in communication with the system, and allowing the users to send messages to these other users; maintaining an index of users previously in communication with to the system to exchange messages with others in near-real time, and no-longer in communication with the system to exchange messages in near real-time; providing users currently in communication with the system with greetings of the users previously in communication with to the system; receiving an originated message from one of the users currently in communication with the system, for one of the users previously in communication with the system in response to a greeting of the one of the users previously in communication with the system; storing the originated message for later retrieval by the one of the users previously in communication with the system.

Other aspects and features of the present invention will become apparent to those of ordinary skill in the art, upon review of the following description of specific embodiments of the invention in conjunction with the accompanying figures.

### BRIEF DESCRIPTION OF THE DRAWINGS

In figures which illustrate, by way of example, embodiments of the present invention,

FIG. 1 is a simplified block diagram telephone sets in communication with a message conference server, exemplary of an embodiment of the present invention;

FIG. 2A illustrates an example directory structure at the message exchange server of FIG. 1;

FIG. 2B-2C illustrate an example schema of a database used in the system of FIG. 1;

FIG. 3 is a simplified block diagram of a portion of the message exchange server of FIG. 1;

FIG. 4 is a flow chart illustrating steps performed by the server of FIG. 1, presenting a user with a main menu;

FIG. 5 is a flow chart illustrating steps performed at the server of FIG. 1, allowing users to browse stored greetings;

FIG. 6 is a flow chart illustrating exemplary steps performed by the server of FIG. 1 in response to a message originator sending a message;

FIG. 7 is a flow chart illustrating exemplary steps performed by the server of FIG. 1 in response to a message recipient receiving messages; and

FIGS. 8-13 are flow charts illustrating exemplary steps performed by the server of FIG. 1 to allow users to exchange messages in near-real time, in manners exemplary of the present invention.

### DETAILED DESCRIPTION

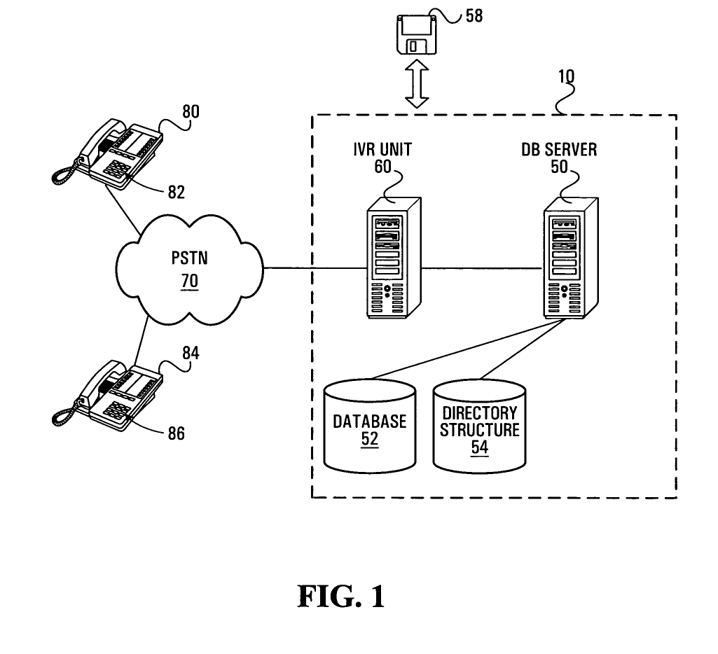

FIG.1 illustrates a system facilitating the exchange of messages in the form of a personal message exchange server 10, exemplary of an embodiment of the present invention. Server 10 includes an Interactive Voice Response (“IVR”) unit 60, in communication with a database server 50. Database server 50 and IVR unit 60 may be interconnected by way of a conventional computer network, such as a local area network (“LAN”).

As will become apparent, server 10 allows the exchange of messages between users in communication with server 10 in one of three ways: stored messages of users may be listened to and replied to; currently interconnected users may exchange messages in near real-time (referred to a “chatting”); and call between currently on-line users may be bridges, to allow for live conversations between users. An operator of server 10, according charges fees for communications between users. Numerous cost charging schemes may be used and are not detailed herein. For example, users may be billed by the minute and/or by the message for using system 10.

To this end, IVR unit 60 further includes a telephone network interface interconnecting server 10 with a telephone communications network, preferably the public switched telephone network (PSTN) 70. As will become apparent, IVR unit 60 allows users to access server 10 by way of PSTN 70. Conveniently, a plurality of users may simultaneously communicate with IVR 60, and with each other, by way of PSTN 70 as detailed below. Example user telephones 80 and 84, interconnected with PSTN 70 are further illustrated. Users of server 10 can communicate instructions and enter information by pressing touchpad 82 on telephone 80, or touchpad 86 on telephone 84 generating DTMF tones understood by IVR unit 60. For the sake of clarity, only two telephones are illustrated. Of course, server 10 may in theory be accessed by any other telephone in communication with PSTN 70.

Database server 50 is preferably a conventional network aware computing device. Database server 50 therefore includes a conventional processor in communication with computer memory and a network interface. As such, server 50 stores and executes a conventional network aware operating system such as a Microsoft Windows XP operating system, a Unix operating system, or the like. As well, database server 50 hosts a conventional file system, preferably controlled and administered by the operating system governing overall operation of server 50. This file system preferably stores a user database 52, and a file directory structure 54. As will become apparent, server 50 provides information contained in the database 54 and files in file directory structure 52 to requesting computing devices. If needed, other databases may of course be hosted by server 50. Software programs to process requests made by interconnected computing devices may be stored in persistent storage memory, such as a hard-disk drive, for execution by server 50. Similarly, software adapting server 50 to perform in manners exemplary of the present invention, including the operating system, is preferably also stored within persistent storage memory at server 50. These and other software applications can be loaded into persistent storage memory of 50 from computer readable media 58 such as a CD-ROM, diskette, tape, or the like.

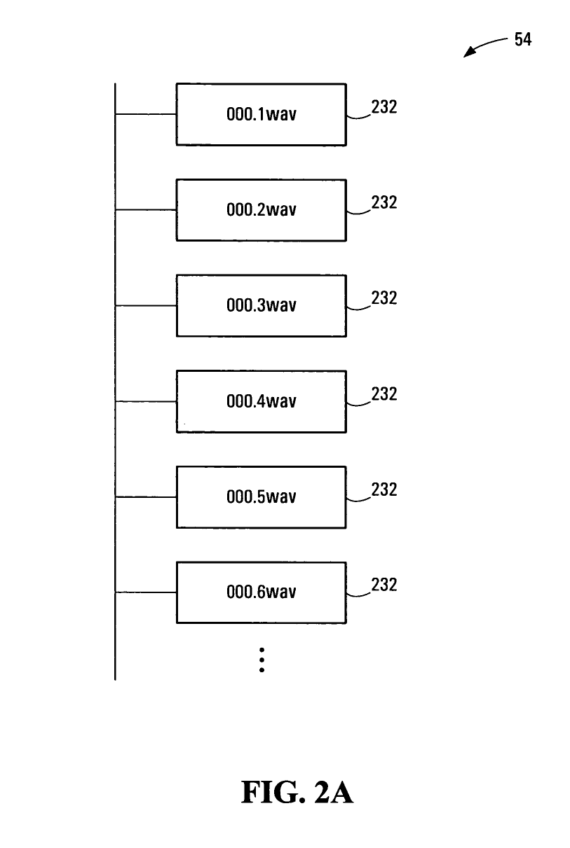

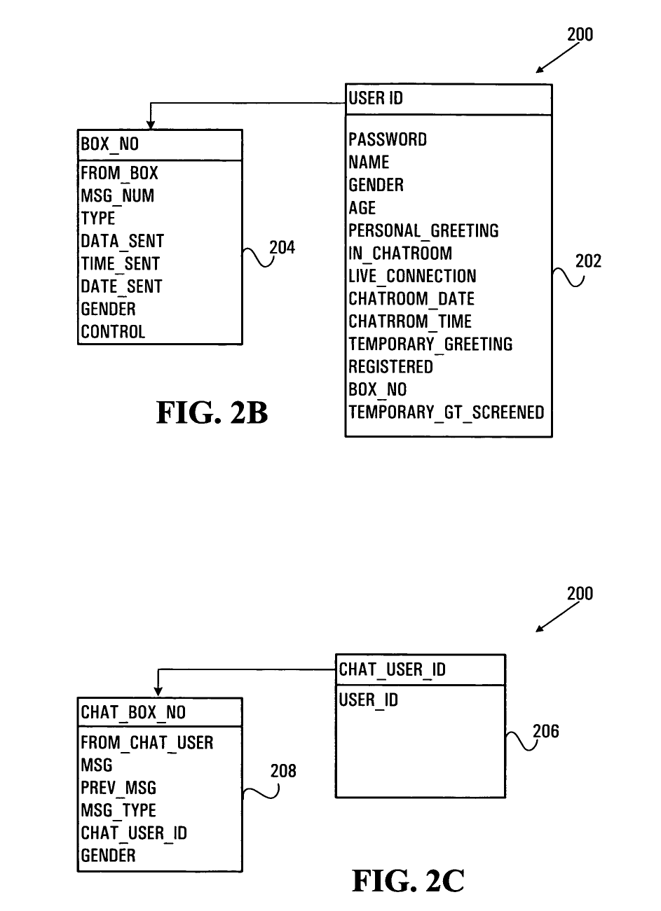

Directory structure 54 may for example be a logical drive in the file system recognised by the operating system controlling server 50. As such, directory structure 54 includes a collection of logically associated directories and files. FIG. 2A schematically illustrates the directory structure 54 and a plurality of stored voice files 232. As illustrated, each voice file is preferably a conventional file handled by the operating system governing operation of server 50. Preferably, each file is identified by a numerical file name identifier.

Example database 52 and is more particularly illustrated in FIGS. 2B, and 2C. Specifically, FIG. 2B and FIG. 2C illustrate example schema 200 defining relational database tables 202, 204, 206 and 208 of database 52 used to index users of system 10 and their messages.

As illustrated, FIG. 2B illustrates an example user table 202 and mailbox table 204.

User table 202 includes fields USER_ID; PASSWORD; NAME; GENDER; PERSONAL_GREETING; IN_CHATROOM; LIVE_CONNECTION; CHATROOM_DATE; TEMPORARY_GREETING; REGISTERED; and BOX_NO fields. The USER_ID field uniquely identifies a user; the PASSWORD field stores a password that the user may set in order to access his/her mailbox and modify the contents of his/her user record. Optionally, a further binary field TEMPORARY_GT_SCREEN maintains an indicator of whether a temporary greeting has been screened, as detailed below. The NAME field is an ASCII field storing the name of the user. The GENDER field stores a flag identifying the user as a male or female. The PERSONAL_GREETING field stores the identifier of a voice file that is used as the user's personal greeting. The IN_CHATROOM field stores a flag that identifies whether the user is currently using the chatroom services, detailed below. The LIVE_CONNECTION field is a flag that identifies whether the use is currently having a bridged connection with another user (also detailed below). The REGISTERED flag is a flag that identifies whether the identified is a temporary or registered user with system 10. The BOX_NO field numerically identifies a BOX_NO record in table 204, associated with the user.

Mailbox table 204 defines records that index voice messages for a user. Each indexed message is identified as belonging to a voice mail box, identified in the BOX_NO field. All messages having the same value in the BOX_NO field define a mailbox. Each mail box is associated with a user and cross-referenced to the BOX_NO field of the user record of table 202. The source of each message is further identified by mail box number, stored in the FROM_BOX field. Each message identifies a numbered file in directory 54, stored in the MSG_NUM field of a record of table 204. Further, the date and time the message was sent are stored in DATE_SENT and TIME_SENT fields. If the user has saved the message, it is stored in the DATE_SAVED field. The gender of the originator of the message is stored in the GENDER field. Finally, control information about the message may be stored in the GENDER field.

FIG. 2B illustrates example CHATROOM table 206 indexing the identity of users currently in communication with server 10 to engage in near real-time exchange of messages (i.e. users said to be in the chatroom) and a chatroom message exchange (CHATMSG) table 208, indexing messages exchanged between users in the chat room, in near real-time.

Table 206 defines records identifying users currently connected to the system who wish are using the chatroom service. Each such user is identified by a record in table 206, containing a unique identifier of that user in the chatroom (stored in CHAT_USER_ID field), and a further uniquely identifying the user among all users (cross-referenced to the USER_ID field of records defined by table 202—FIG. 2A).

Chat message box table 208 indexes messages exchanged between users, currently using the chatroom service. Each chat message is associated with a chat mailbox numerically identified in the CHAT_BOX_NO field. The identity of the chat user is identified in the FROM_CHAT_USER field. This field, identifies a current chat user by the identity of the originating user stored in the USER_ID field of the record of the originating user in table 206. The gender of the originating user is stored in the GENDER field. An identifier of the message for the recipient, in directory 54, is stored by message identifier field MSG. Similarly, an identifier of the message in directory 54 in reply to which the message was created is stored in the PRV_MSG field. As well, an identifier of the message type (request for chat, etc.) is stored in the MSG_TYPE field. Finally, the recipient of the message is identified by the chat user identifier stored in the CHAT_USER_ID field (corresponding to the entry in the CHAT_USER_ID field of a record in table 206).

Directory structure 54 preferably stores voice files 232, reflecting personal messages received for users, sent by others and user greetings. The voice files are encoded with as conventional coder, such as an ITU Recommendation G.711, G. 723 coder or similar coder. As will become apparent, use of tables 202-208 allows the user to review files, as in a conventional voice mail box. Files in directory structure 54 are preferably identified by the unique UserID stored in TEMPORARY_GREETING; PERSONAL_GREETING, MSG_NUM or MSG fields of tables 202, 204 or 208.

Those skilled in the art will appreciate that many other possible fields and tables may be included in database 52. Further, it will be appreciated that the data in database 52 may be structured in many ways, and that the records in databases 52 and directory structure 54 can themselves be organized in many different ways. Database 52 is preferably stored on an alterable storage medium, such as a hard-drive, which may form part of server 50. Database 52 is managed and maintained by server 50 which may further store and execute database management software applications such as FOX Pro, Dbase, or other suitable software designed to manage and maintain the information stored within databases 52. Directory structure 54 could easily be replaced with a suitably formed database.

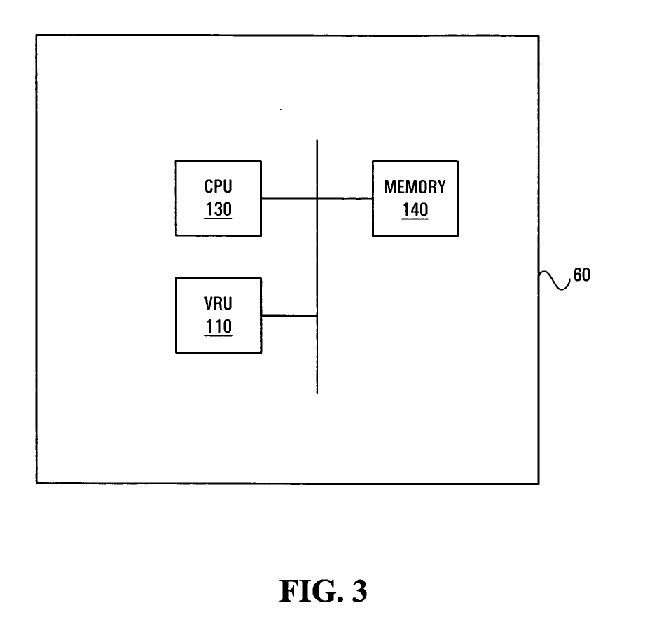

FIG. 3 illustrates an exemplary embodiment of IVR unit 60. IVR unit 60 is preferably a conventional computing device which stores and executes suitable software to act as an interactive voice response processor. As such, unit 60 includes CPU 130 such as an Intel Pentium™ class CPU, and memory 140 including Random Access Memory (RAM) and persistent storage memory. Memory 140 stores computer programs executed by CPU 130, including the voice response program used to prompt users for requisite information, and for storing voice response segments in a computer readable sound format formed by a suitable CODEC. These voice response segments are used to provide verbal information to users accessing message exchange server 10 through a telephone, and to prompt those users to make selections and enter data. These voice response segments can be converted into speech signals compatible with PSTN 70. Again, software and voice response segments stored within memory 140 may be loaded into memory 140 from computer readable medium (not illustrated) which may be CD-ROM, diskette, tape, hard-drive, or the like.

IVR unit 60 preferably also includes a voice response unit (VRU) 110 such as Dialogic D4100ESC or D240SC-T1 IVR card, to provide the physical connection between unit 60 and PSTN 70. Preferably IVR unit 60 includes several such VRUs (only one is illustrated). In the example embodiment, each VRU 110 may provide up to 300 users simultaneous access to IVR unit 60.

VRU 110 preferably also includes a Dual Tone Modulated Frequency (DTMF) logger. This logger decodes DTMF tones corresponding to number keys on a telephone touchpad such as touchpad 82 or 86. Once a communication link between unit 60 and telephone 80 or 84 has been established, VRU 110 receives DTMF signals corresponding to a user's instructions and information. VRU 110 converts these DTMF signals into computer readable format, and preferably forwards these to CPU 130, or to some other module, for further processing.

VRU 110 preferably also includes an analog to digital (A/D) and digital to analog (D/A) converters. The A/D converter may convert speech segments articulated by a user, like a personal greeting, or a voice message, into a digital speech signal that can thereafter be converted into a computer readable sound format using a suitable CODEC. Converted speech segments can then be stored in either database 52 or as a file in directory structure 54. Similarly, the D/A converter may convert voice or speech data received from either memory 140, or from databases 52 and files within directory structure 54, into speech signals. These speech signals may then transmitted from VRU 110 to a recipient in communication with PSTN 70.

Those skilled in the art will appreciate that VRU 110 may include storage space in the form of PROM chips, CD-ROM, hard-drive, or some other suitable medium, to hold a repository of common voice response segments in a suitable computer readable sound data format that can readily be converted into speech signals. These voice response segments may then be synthesized into speech signals and transmitted onto PSTN 70. For example, when an incoming call arrives, VRU 110 may retrieve from its resident storage a voice response segment that corresponds to a standard greeting that is played to all users. That segment may be converted into a speech signal, and transmitted to a user at telephones 80 or 84 through PSTN 70.

In operation, a user wishing to use server 10 (FIG. 1) preferably first registers. An example user may access message exchange server 10 using telephone 80 or 84 by dialing a telephone access number associated with message exchange server 10. The user may thus establish a communications link with unit 60 by way of PSTN 70. In order to register, a user typically enters a previously assigned identifier by way of his or her touchpad. In the event the user has not previously registered and has not yet obtained an identifier/password unit 60 may initiate a registration sequence. Preferably this registration sequence will prompt the user to enter personal information by sending proper voice response segments stored in memory 140 to telephone 80 or 84 prompting the user to enter his/her name and address, age, as detailed above. A user may enter requested information by pressing the appropriate keys on touchpad 82 or 86. The information keyed in by the caller is sent to unit 60 in the form of DTMF signals. VRU 110 (FIG. 3) converts the DTMF signals corresponding to the user's selections into computer data that can be processed by CPU 130 and provided to server 50. The information received from the user is then forwarded to server 50 allowing server 50 to create user records corresponding to tables 202 and 204 and a personal greeting file in directory 54 for the user. At this point, the user may be assigned or choose a password or personal identification number that may be used to access the created account. Alternatively, server 50 may transfer the user to a call center (not illustrated). There, an operator may personally query the user to obtain details that may be provided to server 50 to populate fields of record 200. Optionally personal information need not be solicited or provided to server 10, allowing users anonymous use of server 10. Once registered, the user may also record a personal greeting. Greetings may be screened by an operator of server 10 before being recorded to ensure they do not contain offensive content. The recorded greeting is stored as a file 232 in directory 54.

Optionally, a user may be identified as permanently or temporarily registered with system 10. Permanent registrants may maintain their account with the system after terminating a connection with the system, and may later access their account using their password. The records of temporary users may be deleted once the temporary users have terminated their connection. The status of a user as a permanent registered user or a temporary user may depend on how much information the user is providing, whether the user is paying a fee, or in other ways understood by those of ordinary skill. In any event, the users status as being registered or temporary may be stored in the REGISTERED field of the record defined in table 202 for the user.

As should now be apparent, each user may store a personal greeting. The collection of personal greetings of the various users forming a pool of personal greetings within directory 52. This pool may be browsed by a user so that the user may locate greetings of interest. Once a suitable greeting is located, a browsing user may send a message to a user associated with the located greeting.

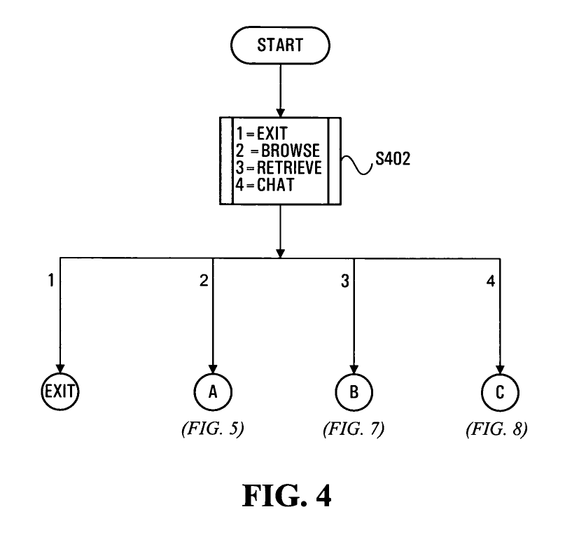

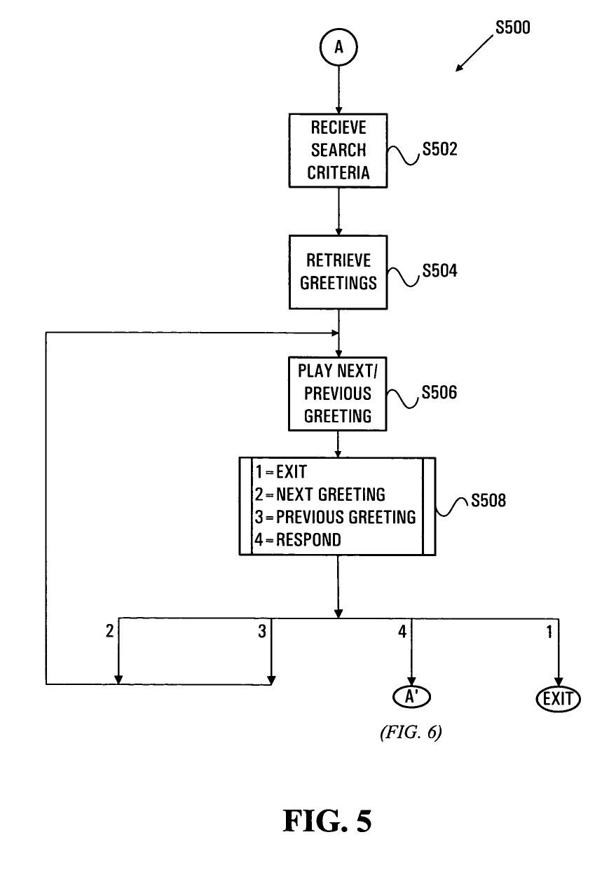

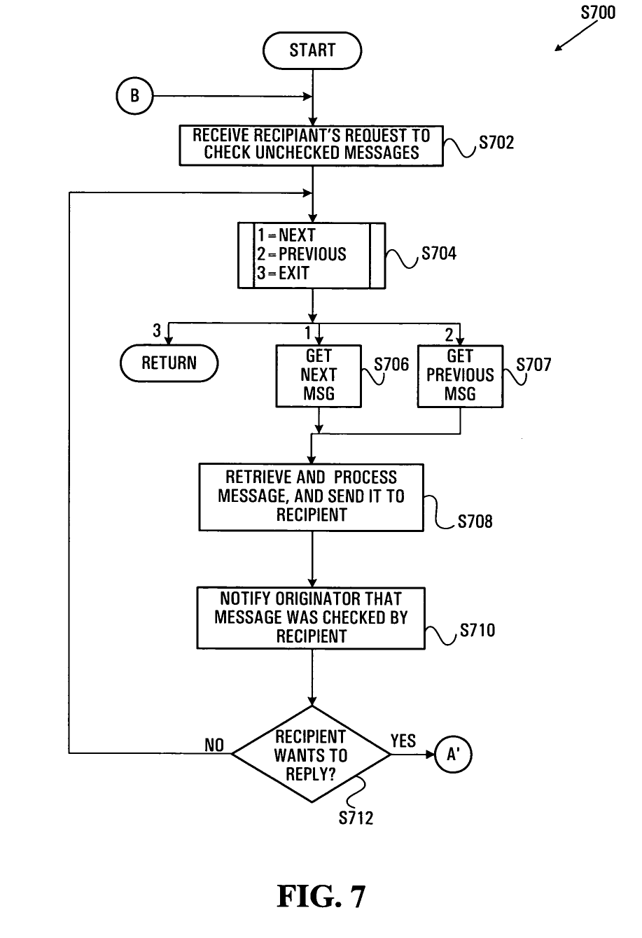

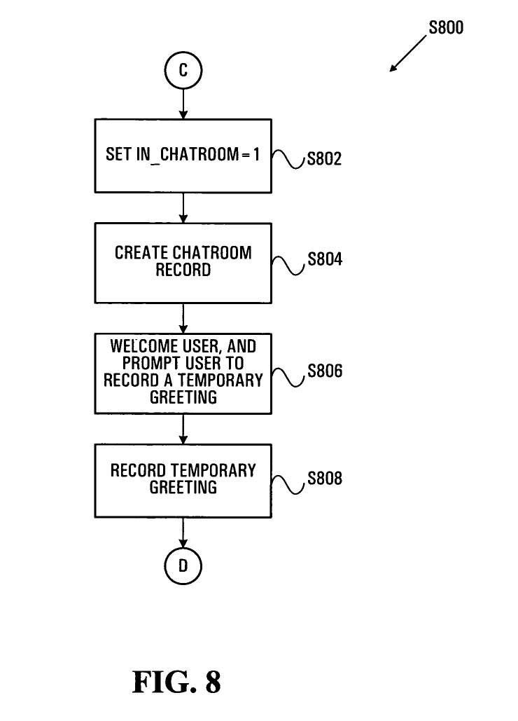

So, after a user has logged on to server 10 for the first or subsequent time and has recorded a personal greeting, the user is next given a series of options. Specifically, the user is given the option of exiting; browsing personal greetings of others stored in database 52; retrieving messages left for the user by others; or joining an in-session conference or chat, as more particularly illustrated in FIG. 4. Decisions may be communicated by way of DTMF tones received in step S402. Specifically, in step S402 the user is prompted to exit; browse; retrieve waiting messages; or join a conference/chat. If a user wishes to exit, as determined in step S402, he/she is allowed exit. In the event a user wishes to browse greetings of others, steps S500 (FIG. 5) and onward are performed. In the event a user wishes to join a chat, as determined in step S402, steps S800 and onward (FIGS. 8-13), detailed below are performed. In the event the user wishes to retrieve messages sent by others, steps S700 (FIG. 7) are performed.

If the user wishes to browse stored greetings of others as determined in step S402, a user may browse greeting files in director 54 by pressing appropriate keys on touchpad 82 or 86 to indicate to server 10 to browse the personal greetings. The user may, in response to prompting from unit 60, make touchpad selections to further narrow the search of database 52 that is to be performed by server 50 in step S502, as illustrated in FIG. 5. For example, the user may press a key corresponding to the user gender preference, press another key corresponding to the user's age-range preferences, and so on. In response to the user's request to browse the greetings, unit 60 sends a request to server 50 to access database 52 to identify the personal greetings of users meeting the search criteria and retrieve the personal greetings corresponding to the user's request in step S504. The retrieved greetings are provided to unit 60 and VRU 110 that converts the personal greetings into speech signals that are provided to PSTN 70. Users at telephones 80 and 84 can then listen to the retrieved greetings. Greetings may be sequentially presented in step S506, as controlled by appropriate DTMF inputs provided in step S508. A user is, of course also given the option to exit between greetings in step S508.

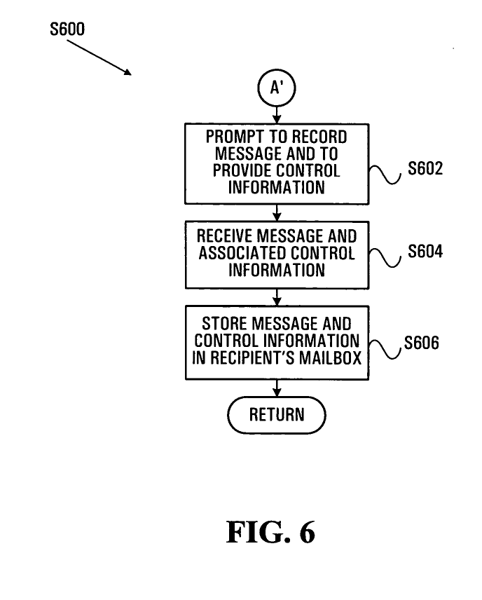

Once a user has reviewed personal greetings of others, the user—acting as a message originator—using example telephone 80, may wish to send a message to another user as determined in step S508. Steps performed at message exchange server 10 to allow a user to send a personal message, exemplary of an embodiment of the present invention are more particularly illustrated in FIG. 6.

As illustrated, once a recipient is identified as a result of browsing, and the originator has indicated that he or she wishes to send a message to that recipient, the originator is prompted to input an actual message in step S616. As well, the message originator may be prompted to input message control information that could include an indicator of urgency, or destination for the message. The message and control information may be received at message exchange server 10 in step S618. A voice file is stored and saved within directory 54 and a corresponding record in table 204 is created and populated, identifying the message originator (in the FROM_BOX field of the record); the recipient (in the BOX_NO field); the message file (in the MSG field); the type of message (in the TYPE field); the date sent (in the DATE_SENT field) and the gender of the originator (in the GENDER field). Further, control information may be stored in the CONTROL field.

Specifically, the originator speaks the to-be recorded message at telephone 80. The originator may identify the message recipient by replying to a greeting or by entering an identification number associated with the recipient. The user may enter the identifying information by pressing suitable keys on touchpad 82. Other control information, such as the urgency of the message, may also be entered by the originator through touchpad 82 when prompted by unit 60. Of course, the control information is received in the form of DTMF signals. The DTMF signals corresponding to the originator's selections are then converted into computer readable signals by VRU 110. Once the originator has sent all the control information, the originator preferably starts recording the actual personal message that is to be sent. Since the message the originator is recording arrives at unit 60 as an analog signal, the A/D converter of VRU 110 may convert the analog signal into a digital signal which can then be converted into a computer readable sound format. The processed message and the control information are then all forwarded to server 50.

FIG. 7 illustrates exemplary steps performed by message exchange server 10 to allow a recipient, by way of an example telephone 84, to retrieve (i.e. listen or the like) messages sent by others, in response to choosing to do so in step S402 (FIG. 4). Specifically, in step S702, server 50 receives a user's request to check messages. Next, in step S704, server 50 retrieves a user's choice to advance to next message; previous message or exit. Accordingly, in steps S706 or S707 server 50 queries the table 204 for the next or previous message for the user. This may be done through use of the MSG_NUM field. An identified message may be retrieved from directory 54 and played in steps S708. The voice data is converted into speech signals using VRU 110. The message is then sent to the recipient at telephone 84 by way of PSTN 70. Messages not yet heard may be identified and played first (as identified by a populated DATESAVED field). Once the user chooses to stop reviewing messages (as selected in step S704) the user is returned to step S402 and may perform some other operation.

In step S710, the originator may optionally be notified that the message has been checked. Moreover, in step S712, the recipient is given the opportunity to send a reply. After each message is checked it may be deleted, or saved at the option of the user (not specifically illustrated). If the message is saved, the DATE_SAVED field is populated of the record for the message in table 204. If the recipient wishes to reply, steps S602 (FIG. 6) and onward are performed.

After the recipient finishes checking all the unchecked messages, the recipient may subsequently respond to one or all of the messages. Message exchange server 10 may then execute the steps illustrated in FIG. 6, as described above.

Steps performed at server 10 to allow a user to access and use server 10 to join a conference/chat room of two or more users, and potentially initiate a one-on-one communication with one of these users exemplary of an embodiment of the present invention are more particularly illustrated in FIGS. 8-13. After logging in and upon selecting to enter a conference or chat, as determined in step S402 (FIG. 4), the user is said to metaphorically enter the “chat room”. As a consequence of choosing to enter the chat room, server 10 under software control sets the IN_CHATROOM flag of a record in table 202 associated with the user to signify that the user is part of the chat in step S802. As well, a record in table 206 identifying the user is created in step S804. Once in the chatroom, the user may browse the temporary greetings of others currently part of the conference/chat. For the purposes of illustration, a user at telephone 80 (FIG. 1) will be referred to a “browsing” user. Steps detailed in FIGS. 8-13, however, are independently performed for each user.

Effectively, as will become apparent, users in the chatroom may communicate with each other by exchanging messages that are received almost immediately, thereby allowing near-real time communication of users.

Thus, in step S806 server 10 may provide the browsing user with a “Welcome” prompt providing the browsing user with a brief description of the chat room. To effect this, appropriate voice response segments stored in memory 140 may be converted into speech signals and sent to the user at telephone 80 via PSTN 70.

As well, in step S806 unit 60 provides the example browsing user a voice sequence that prompts the user to record a temporary personal greeting. The temporary greeting uttered by the user at telephone 80 may be converted to a suitable format and stored as a voice file in director 52. The temporary greeting voice file may be indexed in the TEMPORARY_GREETING field of the record for the user in table 202 in step S808. Prior to storage, the greeting may be screened by an operator of server 10 to ensure that its content is appropriate and not offensive. If inappropriate, the greeting may be rejected and steps S806-S808 may be repeated. Optionally, not all temporary greetings need be screened and a further indicator of whether a temporary greeting has been screened may be maintained in the user record of table 202 in the TEMPORARY_GT_SCREEN field.

The temporary greeting is used by the user to identify him or herself to other participants in the chat room. Other users using the chat room may send message or request a live one-on-one conversation in response to hearing the temporary greeting. Preferably, a new temporary greeting is recorded each time a user enters the chat session.

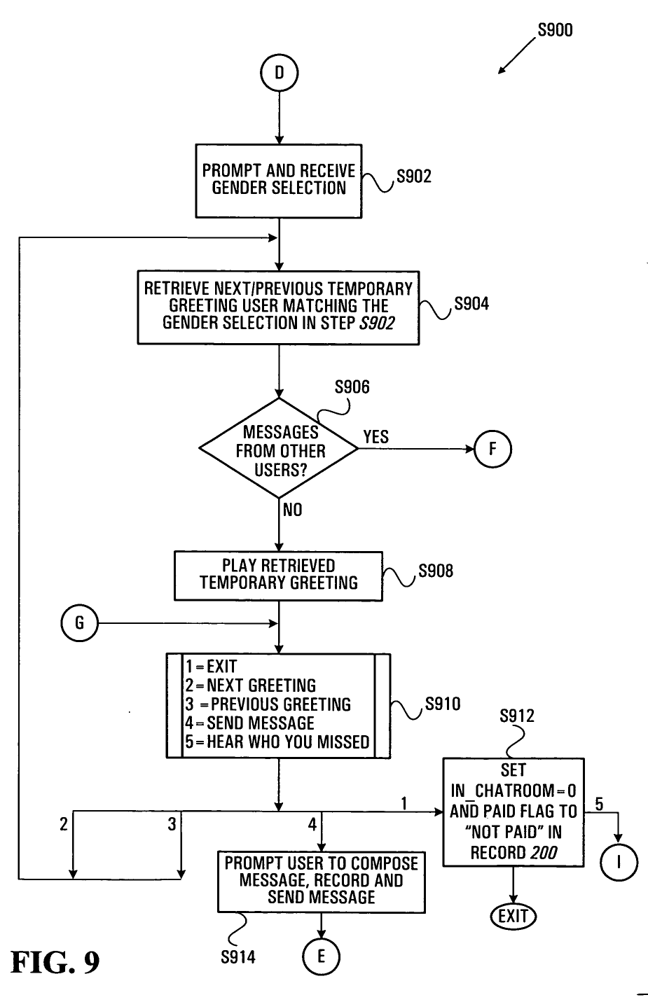

Once steps S800 have been performed the browsing user is prompted by server 10 to provide a gender selection, indicating whether the browsing user would like to browse the temporary greeting of males or females in step S902 (FIG. 9).

Optionally, at this point server 50 may provide an audible message to the browsing user indicating the total number of other users currently in the chat room, matching the user's search criteria. This may be effected by querying database 54 for the number of records matching the browsing user's gender selection that are currently in the chat room (not specifically illustrated in FIG. 9).

Next, in steps S904, server 10 retrieves temporary greetings of others currently in the chat room (retrieving the temporary greeting of users identified in table 206, currently in the chat) associated with other users, matching the browsing user's gender preference as determined in step S904.

However, prior to presenting any retrieved temporary greeting, server 10 determines in step S906 if any messages from other users have been sent to the browsing user, by querying table 208 to assess if any chat messages are waiting for the user. That is, as multiple users are concurrently on-line in the “chat room” they may send messages to each other and ultimately establish a live one-on-one connection.

Messages to be exchanged during a chat session may be stored in directory structure 54 (FIG. 1). Messages for current users of the chat session are indexed in the CHATBOX table 208 of FIG. 2B. Each message within the data/directory structure includes an identifier of the message originator and recipient, as well as the gender of the originator, and an identifier of the message to which the originating message responds. In step S906, this table may be queried for messages destined for the browsing the user.

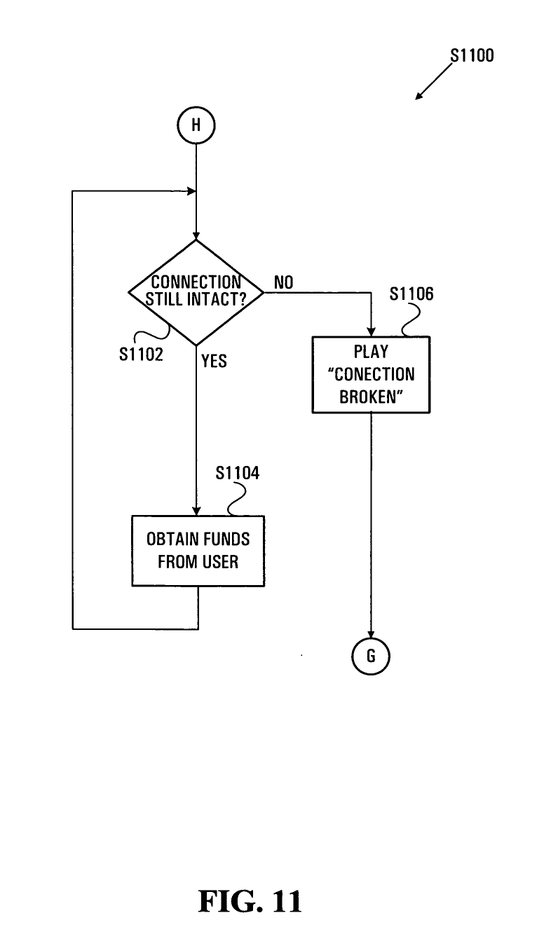

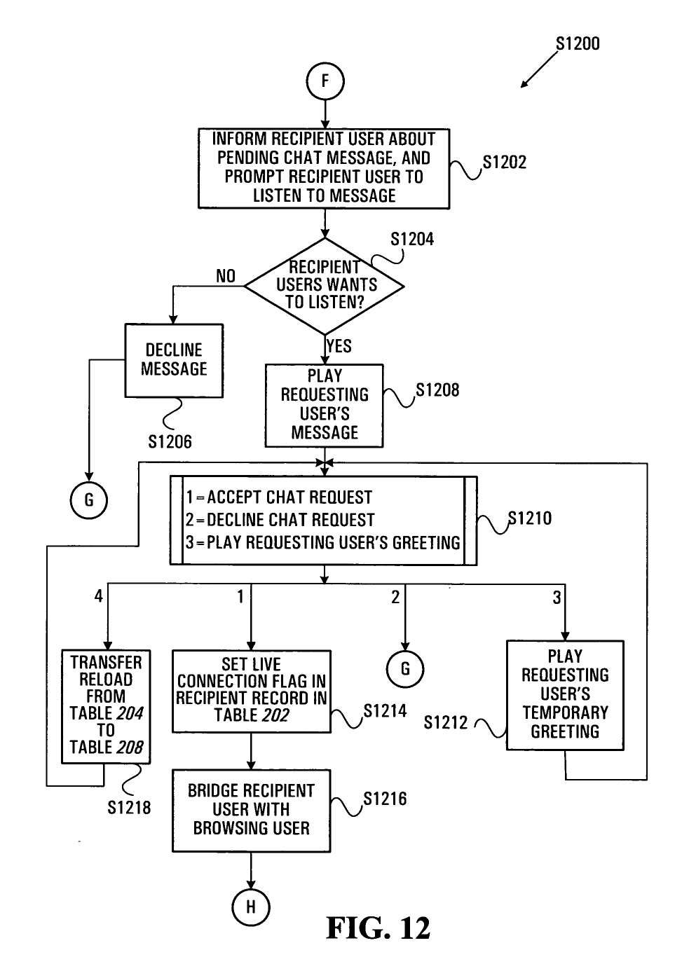

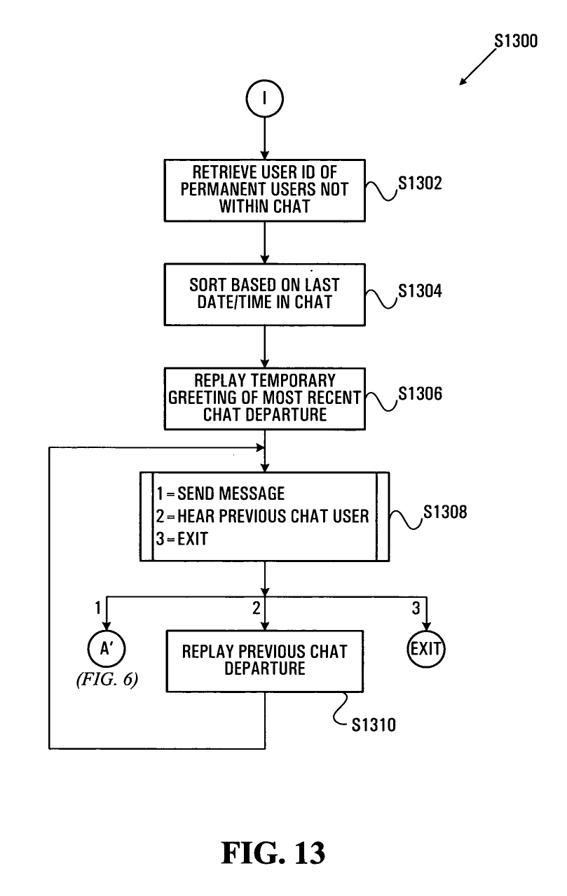

Specifically, if a message is waiting, steps S1200 in FIG. 12 are performed. That is, in step S1202 the browsing user is advised of the pending message, and given the option to listen to the pending message. If the browsing user does not wish to listen, as determined in step S1204, a “decline message” may be sent to the message originator in step S1206. Thereafter, step S914 and onward are performed, allowing the browsing user to continue browsing messages. If the browsing user wishes to listen to the message, as determined in step S1204, the message is played in step S1208. At the conclusion of the played message, the browsing user is given the options of accepting or declining any chat invitation associated with the message in step S1210. As well, the user is given the option of replaying the message originator's temporary greeting or saving the chat message in step S1210. If the browsing user declines any chat invitation, a suitable message may be generated and provided to the requesting user, and steps S914 and onward are performed. If the user wishes to listen to the originator's greeting it is replayed in step S1212 and step S1210 is repeated. In the event the browsing user wishes to establish a live one-on-one connection with the message originator, calls associated with the browsing user and the message originator are bridged in step S1216. In step S1214 the LIVE_CONNECTION flag of the browsing user is set, indicating that the browsing user is engaged in a live one-on-one conversation. Thereafter step S1100 detailed in FIG. 11 are performed to monitor the bridged call.

If the user wishes to save the chat message, server 10 extracts the contents of the record in table 208 identifying the message, and transfers its contents to a new record in table 204 in step S1218. Specifically, the user identifier (stored in USER_ID field of the record of table 206) is used to identify a mail box number (BOX_NO). Similarly, the FROM_CHAT_BOX number of the chat message is used to identify the user identifier of the originating user. A new record in table 204 is formed, and the BOX_NO and FROM_BOX fields are populated. Similarly, the MSG_NUM and GENDER field of the record of table 204 may be populated directly from the MSG and GENDER fields of the record of table 208. The DATE_SAVED field may be updated with the current time. The saved message may now be replayed like any other saved message in steps S700 (FIG. 7) and onward. Next step S1210 and onwards are repeated.

If no messages for the browsing user are waiting, and the temporary greeting of a potential recipient user is played for the browsing user in step S912. In step S914 server 10 provides a menu of the possible follow-up actions available to the browsing user. Preferably, the options include (1) exiting; (2) accessing the next personal greeting record matching the user's search/access criteria; (3) accessing the previous greeting record; (4) sending a message to a user, including a possible request to initiate a one-on-one chat; and (5) hearing temporary greetings of users no longer in the chat room.

If the browsing user chooses to exit to the main menu, server 10 under software control re-sets the IN_CHATROOM flag of the user record in table 202 in step S922 signifying the user is no longer in the chat room. As well, the chatroom date and time field of the user record are updated to reflect the date and time the user has left the chat room. Server 10 then proceeds to execute steps S400 and onward illustrated in FIG. 4. Conveniently, any message for the browsing user within the directory 54 and database table 202 used to exchange chat messages may deleted upon the user exiting. If the browsing user decides to advance to the next or previous message, steps S904 and onward are repeated for the next or previous message, respectively.

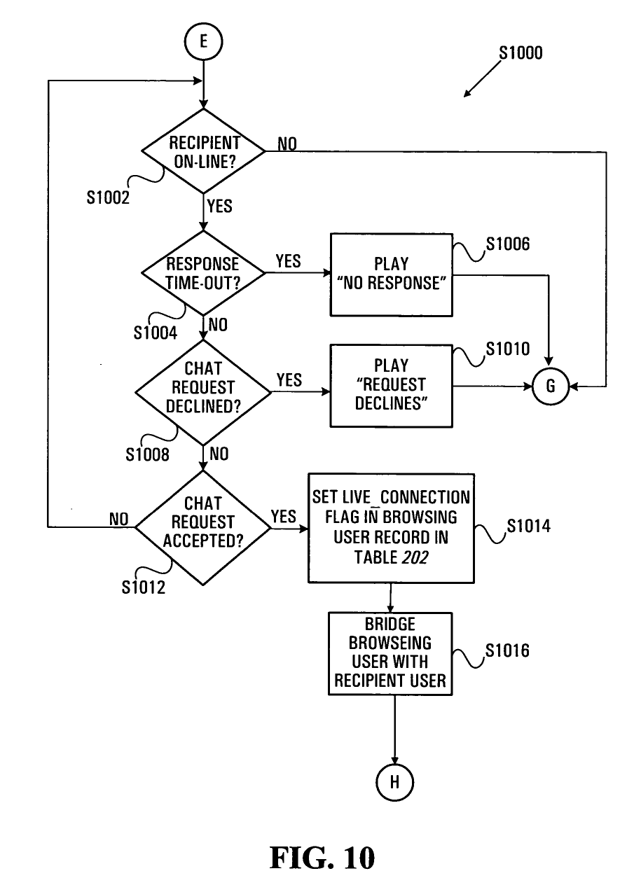

If the browsing user wishes to request a live one-on-one connection with the recipient user associated with the replayed temporary greeting, server 10 proceeds to record a message in step S916. A recorded message including originator and recipient identifiers may be stored in the above described data structure used for the exchange of chat room messages. Thereafter steps S1000 illustrated in FIG. 10 are performed to await the recipient user's response to the invitation.

As illustrated in FIG. 10, in step S1002 server 10 first assesses whether the recipient user is still in the chat room by checking IN_CHATROOM field of the record of table 202 of the recipient user. If not, steps S914 and onward are again repeated. If, so server 10 assess whether a response has been received within a suitable “time out” period in step S1004. If none is received within the time-out period, a prompt indicating “No response” may be played in step S1006 and steps S914 and onward are repeated. If the request for a chat is declined, as determined in step S1008, an appropriate prompt may be provided to the browsing user in step S1010 and steps S914 and onward are repeated. If the chat request is accepted as determined in step S1012, the PSTN connection between the browsing user and server 10 and the PSTN connection between the recipient user and server 10 is bridged in step S1016. This may be accomplished by bridging the PSTN lines at server 10 using the VRUs associated with these lines in a manner understood by those of ordinary skill. The two users may then speak to each other in real time. Conveniently, neither user needs to reveal his/her identity. Before bridging, the LIVE_CONNECTION flag of the browsing user is set in step S1014.

Server 10, executing similar steps for the recipient user, on the other hand executes steps S1200 for the recipient user in response to the browsing user dispatching a message for the recipient user, presenting the recipient user with the message. Again, a response is solicited in steps S1204-S1216.

Once the live chat connection between the two users is established, the browsing and recipient user can converse freely for as long as they wish. As long as the two users are chatting, server 10 continues to monitor whether the both users are still connected, and that the paying user or users have sufficient funds. Steps S1100 are thus performed, for both the browsing and recipient users.

In steps S1102-S1104 server 10 periodically examines whether the other user is still connected by examining the LIVE_CONNECTION field of the record in table 202 associated with the other user. If server 10 determines that the other user is no longer participating in the live connection, server 10 in step S1112 sends to the remaining user the voice sequence “Connection broken”. Thereafter, server 10 returns to step S914 and prompts the remaining user for the next action it wishes to take.

Either user may terminate the live chat connection at any time by pressing a suitable DTMF key, for example, the ‘#’ key. This tone may be monitored in steps S1100 (not specifically illustrated), and the connection can be broken. As a consequence, server 10 may allows the user to resume his/her previous activity by repeating steps S914, and onward. Additionally, field 227 associated with the user may be set to indicate the user is no longer engaged in a live connection in step S1114.

In the event a user using the chat room does not have any interest in, or success with communicating with users currently connected and in the chat room mode, the user may choose to “hear who he or she missed”, by entering option 5 in step S914 (FIG. 9). In response, server 50 performs steps S1300 (FIG. 13). As illustrated in FIG. 13, server 50 retrieves the user records of other users who have previously entered the chat room in step S1302. For reasons that will become apparent, only records of those users who have permanent mailboxes (i.e. mailboxes that will not be deleted when a user exits use of server 50 identified by the REGISTERED flag of the record of table 202) are retrieved. Records of these users may be sorted by date/time of their last presence of the chatroom (identified by fields DATE and TIME of table 202—FIG.2A) in step S1304. Next, the temporary greeting of the user most recently in the chat room is replayed in step S1306. Thereafter, the user is given the option to the retrieved user's temporary greeting, hear more temporary greetings of users no longer in the chat room, or exit in step S1308. Conveniently, if all temporary greetings are screened only screened greetings are replayed. If only some temporary greetings are screened, retrieved temporary greeting in step S1302 may be limited to screened temporary greetings (as indicated by the TEMPORARY_GT_SCREEN field).

If the user wishes to hear more temporary greetings of users no longer in the chatroom, the record of the next most recent user to have left the chat room is assessed in step S1310, and his or her temporary greeting is replayed, and options of step S1308 are re-presented. If the user currently in the chat room wishes to send a message to the user whose temporary greeting has just been heard, a message is originated in the same way as messages that respond to the user's permanent greeting are generated. That is, steps S600 (FIG. 6) are performed, and a message is placed in the recipient user's mailbox (i.e. indexed in table 204 of the user). For this reasons, temporary greetings of only those users who have mailboxes are replayed when those users are not on line.

In this way, users in the chat room are not limited to sending messages to only users currently in the chat room. They may instead originate messages to be received by user's previously in the chat room. This, of course, gives users in the chat room a greater selection of other users with whom they may interact. It may be of particular interest at times when few users are truly currently using the chat room service. Moreover, it gives chat room users greater to use the chat room services for greater periods of time. Conveniently, users currently in the chat room may be charged for use of the server based on use of the service. For example, charges may be levied based on the number of greetings a user listens to, or based on the time spent listening messages. Other charging techniques are disclosed in U.S. Pat. No. 09/985,040, the contents of which are hereby incorporated. By increasing the variety and number of greetings a user is encouraged to spend more time and listen to more messages.

As will also be appreciated, while the organization of hardware and software components, databases and directory structure have been illustrated as clearly delineated, a person skilled in the art will appreciate that this delineation and organization is somewhat arbitrary. Numerous other arrangements of hardware, software and data are possible. For example, database server 50 and IVR unit 60 could be combined into a single unit whereby that unit would have similar components as those described in relation to server 50 and IVR unit 60. Similarly, database 52 could be organized in numerous ways, using relational or object oriented structures. Similarly, data stored in such databases could be stored in numerous equivalent ways. Similarly, directory structure 54 could be replaced by any number of equivalent data organizations, including, for example, one or more databases. Furthermore, the server as illustrated may also be interconnected to a packet switched data network, such as the public Internet.

It will be further understood that the invention is not limited to the embodiments described herein which are merely illustrative of a preferred embodiment of carrying out the invention, and which is susceptible to modification of form, arrangement of parts, steps, details and order of operation. The invention, rather, is intended to encompass all such modification within its scope, as defined by the claims.

1. A method of operating a system providing a service allowing a plurality of users to communicate with each other in near real-time, said method comprising:
for each of said plurality of users storing a temporary greeting;
allowing users currently in communication with said system to receive to temporary greetings of other users currently in communication with said system, and allowing said users to send messages to said other users;
maintaining an index of users previously in communication with said system to exchange messages with others in near-real time, and no-longer in communication with said system to exchange messages in near real-time;
providing users currently in communication with said system with greetings of said users previously in communication with said system;
receiving an originated message from one of said users currently in communication with said system, for one of said users previously in communication with said system response to a greeting of said one of said users previously in communication with said system;
storing said originated message for later retrieval by said one of said users previously in communication with said system.

2. The method of claim 1, wherein said system permits bridging of telephone calls between said users currently in communication with said system.

3. The method of claim 2, wherein greetings of said users previously in communication with said system are presented sequentially in an order reflective of when said users were previously in communication with said system.

4. The method of claim 1, wherein users of said system are charged based on the amount of time spent in communication with said system.

5. The method of claim 1, wherein users of said system are charged based on the number of messages listened to.

6. The method of claim 1, wherein said index of users previously in communication with said system to exchange messages with others in near-real time, and no-longer in communication with said system to exchange messages in near real-time is part of a database.

7. The method of claim 1, wherein said greetings are stored voice files.

8. The method of claim 7, wherein said messages are voice messages.

9. The method of claim 8, wherein said originated message comprises a voice message.

10. The method of claim 9, wherein said providing is performed in response to receiving DTMF options entered by one of said users currently in communication with said system.

11. A computer readable medium, storing computer executable instructions that when loaded at a message exchange server, used to exchange messages between users, adapts said message exchange server to:
for each of said plurality of users store a temporary greeting;
allow users currently in communication with said server to receive temporary greetings of other users currently in communication with said server, and allowing said users to send messages to said other users;
maintain an index of users previously in communication with said server to exchange messages with others in near-real time, and no-longer in communication with said server to exchange messages in near real-time;
provide users currently in communication with said server with greetings of said users previously in communication with said server;
receive an originated message from one of said users currently in communication with said server, for one of said users previously in communication with said system in response to a greeting of said one of said users previously in communication said system;
store said originated message for later retrieval by said one of said users previously in communication said system.

12. The computer readable medium of claim 11, further storing computer executable instructions that when loaded at said message exchange server, adapts said message exchange server to bridge telephone calls between said users currently in communication with said server.

13. The computer readable medium of claim 11, further storing computer executable instructions that when loaded at said message exchange server, adapt said message exchange server to, present greetings of said users previously in communication with said server sequentially in an order reflective of when said users were previously in communication with said server.

14. The computer readable medium of claim 11, further storing computer executable instructions that when loaded at said message exchange server, adapt said message exchange server to charge users of said system based on the amount of time spent in communication with said system.

15. The computer readable medium of claim 11, further storing computer executable instructions that when loaded at said message exchange server, adapt said message exchange server to charge users of said system are charged based on the number of messages listened to.

16. The computer readable medium of claim 11, further storing computer executable instructions that when loaded at said message exchange server, adapt said message exchange server to store said greetings as voice files.

17. The computer readable medium of claim 11, further storing computer executable instructions that when loaded at said message exchange server, adapt said message exchange server to store said messages as voice messages.

18. An apparatus facilitating exchange of voice messages, comprising:
a network interface interconnecting said apparatus to a communications network, to allow a message originator to dispatch a voice message to a recipient;
a processor in communication with said network interface;
memory for storing voice messages to be exchanged,
said memory storing program instructions, adapting said apparatus to:
for each of said plurality of users store a temporary greeting;
allow users currently in communication with said server to listen to temporary greetings of other users currently in communication with said apparatus, and allowing said users to send messages to said other users;
maintain an index of users previously in communication with said apparatus to exchange messages with others in near-real time, and no-longer in communication with said apparatus to exchange messages in near real-time;
provide users currently in communication with said apparatus with greetings of said users previously in communication with said apparatus;
receive a message from one of said users currently in communication with said apparatus, for one of said users previously in communication with said system in response to a greeting of said one of said users previously in communication with said system;
store said message for later retrieval by said one of said users previously connected.

19. The apparatus of claim 18, wherein said interface comprises a telephone network interface.
